(19) United States
(12) Patent Application Publication
(10) Pub. No.: US 2025/0342453 A1
(43) Pub. Date: Nov. 6, 2025

(54) SYSTEM AND METHOD FOR ONLINE BILL PAYMENT DELEGATION

(71) Applicant: Wells Fargo Bank, N.A., San Francisco, CA (US)

(72) Inventors: Peter Rozovski, Concord, CA (US); Tina D. McCoy, Charlotte, NC (US); Manish Agarwal, Waxhaw, NC (US)

(21) Appl. No.: 18/168,290

(22) Filed: Feb. 13, 2023

(51) Int. Cl. G06Q 20/10; G06Q 20/22; G06Q 20/38; G06Q 20/40

(52) U.S. Cl. CPC G06Q 20/102; G06Q 20/227; G06Q 20/3821; G06Q 20/40; G06Q 2220/00

(57) ABSTRACT

A method includes presenting, to a user, a list of bill payment accounts included in a bill payment system, wherein each bill payment account in the list of bill pay eligible bank accounts of the user is delegable by the user. The method also includes receiving, from the user, a selection of a bill payment account included in the list of bill payment accounts and a to-be delegate identifying information, and transmitting a communication comprising a request for bill payment delegation based on the selection and on the pending delegate identifying information. The method additionally includes authenticating a second user via a user credential linked to the pending delegate information, receiving, from the second user, an indication of acceptance of a delegate role for the bill payment account, and applying the delegate role in the bill payment system to enable access to the bill payment account via the user credential based on the indication of acceptance.

### TECHNICAL FIELD

The present disclosure generally relates to online bill payment, and more specifically to online bill payment delegation.

### BACKGROUND

Certain online systems include bill payment systems that provide for transactional exchange of funds between monetary accounts. For example, an account owner initiates a payment transaction via the bill payment system that transfers funds from a bill payment account into a third party entity account, such as a mortgage holder account, vehicle loan holder account, and so on. The bill payment system then transfers the funds from the bill payment account.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. Various ones of the appended drawings merely illustrate example embodiments of the present inventive subject matter and cannot be considered as limiting its scope.

FIG. 1 illustrates an example transactional system that includes a delegate-enabled bill payment system, according to some embodiments.

FIG. 2 is a flowchart for an example bill payment delegation process, according to some embodiments.

FIG. 3 is a flowchart for an example bill payment process for applying financial filters to match certain geographic areas, and to present financial information for the matched geographic areas, according to some embodiments.

FIG. 4 is a flowchart for an example bill payment delegator process, according to some embodiments.

FIG. 5 is a screenshot of a graphical user interface (GUI) suitable for displaying bill payment account summary information and for navigating to certain account delegation views, according to some embodiments.

FIG. 6 is a screenshot of a GUI suitable for displaying bill payment delegation summary information and for providing certain delegation functionality, according to some embodiments.

FIG. 7 is a screenshot of the GUI of FIG. 6 showing a new GUI section that is dynamically created, according to some embodiments.

FIG. 8 is a screenshot of the GUI of FIG. 6 showing a new GUI delegation access details section that is dynamically created, according to some embodiments.

FIG. 9 is a screenshot of the GUI of FIG. 6 illustrating an activation of a “modify delegate” tab, according to some embodiments.

FIG. 10 is a screenshot of the GUI of FIG. 6 illustrating an activation of a “delegated to me” tab, according to some embodiments.

FIG. 11 is a screenshot of a GUI suitable for switching between various delegated accounts, according to some embodiments.

FIG. 12 is a screenshot of the GUI of FIG. 11 illustrating an activation of a delegation control, according to some embodiments.

FIG. 13 is a block diagram depicting a machine suitable for executing instructions via one or more processors, according to some embodiments.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

The techniques described herein solve various technical problems such as securely delegating one or more users to have access (e.g., online access) to a bill payment account using a variety of delegate roles. In certain examples, a delegate-enabled bill payment system provides online access to a variety of bill payment accounts. An account owner then initiates, in a secure manner, the delegation of one or more bill payment accounts to certain entities (e.g., users) by “nominating” the entities as pending delegates. A message is then sent to the pending delegate entities, which can securely log in to the delegate-enabled bill payment system and decide to accept the delegation. An acceptance of the delegation then creates a delegate relationship between the entity and the bill payment account.

In some examples, a bill payment account is delegable (e.g., assignable to a delegate) by the account owner as well as by a delegate having certain delegate roles, such as a delegate full access role. Different delegate roles can be selected for the delegate. For example, a view only delegate role provides read-only access into the bill payment account, and cannot initiate or modify any payments. An edit only delegate role enables the editing (e.g., updating a monetary amount for a payment and changing a changing a payment date) for an existing money transfer and/or canceling an existing payment, but cannot create a new payment. A pay only delegate role enables the delegate to make a payment, without being able to perform any other action. The delegate full access role enables creating a new payment, viewing account activity, editing a payment, adding new delegates, editing a delegate (e.g., changing a delegate role), and/or canceling delegation for a delegate.

The account owner and certain delegates can also audit delegate activity, such as payments initiated, payments edited, payments canceled, and so on. The account owner and certain delegates can also withdraw delegation authority to remove delegates from having access to the bill payment account, and/or change delegate roles for the delegates. Likewise, the delegates can remove themselves from access to the bill payment account. The techniques described herein include a graphical user interface (GUI) that provides the delegate entity and the account owner for comprehensive visualization of bill payment account information as well as for initiating, editing, and auditing payments. By providing for bill payment account delegation, the techniques described herein enable more efficient bill payment and distributed management for bill payment accounts.

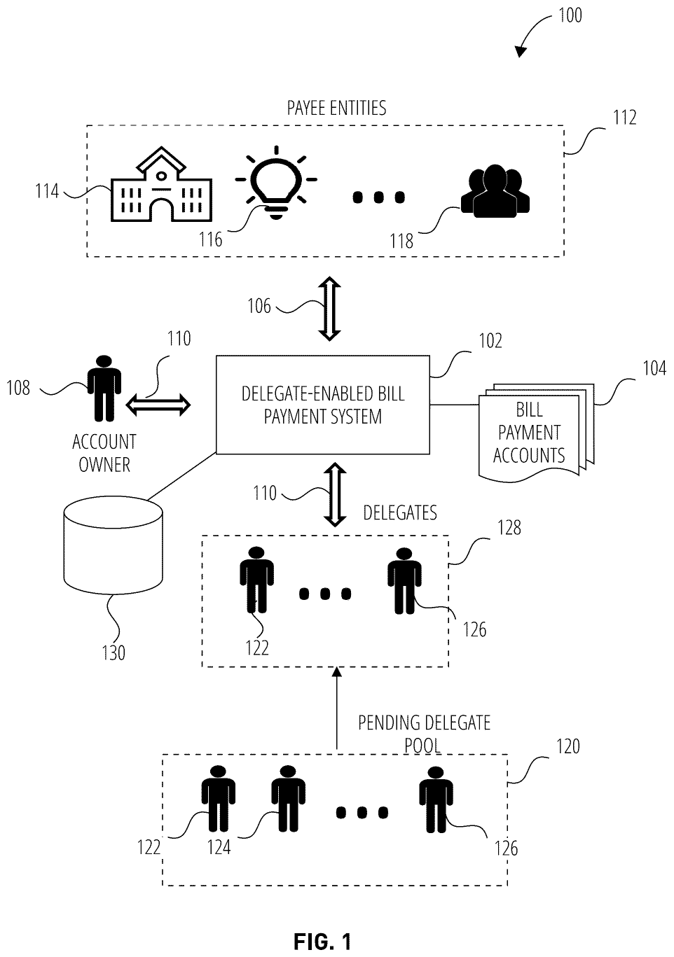

FIG. 1 illustrates an example transactional system 100 that includes a delegate-enabled bill payment system 102, according to some embodiments. In the depicted example, the delegate-enabled bill payment system 102 provides for fund transfer services for a variety of bill payment accounts 104. As used herein, a bill payment refers to a transfer of funds from a first bill payment account into a second account. As the name bill payment suggests, the transfer of funds may be related to the payment of an invoice or a bill, such as a mortgage payment, a utility bill payment, a car loan payment, an insurance bill payment, and so on. The transfer of funds from the bill payment accounts 104 can be processed via a fund transfer network 106, such as a Federal Reserve System network (e.g., via an American Bankers Association (ABA) routing number, an automated clearing house (ACH), or other electronic funds transfer), a Society for World Interbank Financial Telecommunication (SWIFT) network, interbank networks, intrabank networks, peer-to-peer payment system networks (e.g., Venmo, Zelle®), and the like.

In operations, an account owner 108 can log into the delegate-enabled bill payment system 102 via a secure login system 110 using certain authentication techniques (e.g., two-factor authentication), and initiate a bill payment transaction that transfers funds from the bill payment accounts 104 into accounts held by one or more payee entities 112. The payee entities 112 can include a variety of payees, such as financial institutions 114 (e.g., banks, credit unions, insurance institutions, loan holding institutions, and so on), utilities 116 (e.g., power utilities, gas utilities, cell phone providers, internet providers, cable television providers), individual entities 118 (e.g., business associates of the account owner, family members, friends, and so on). The account owner can be an individual and/or a business entity, such as a limited liability corporation (LLC), an S-corporation, an incorporated entity (e.g., Inc.), a non-governmental organization (NGO), and so on.

In some cases, it would be beneficial for the account owner 108 to delegate certain bill payment roles. For example, if the account owner 108 is an individual, the account owner may opt for vacation time and delegate certain bill payments to a family member when out on vacation, at college, when a family member is elderly, etc. (e.g., parent and child). Likewise, if the account owner 108 is a small business, the employee in charge of bill payments may benefit from having a backup bill payer. Accordingly, the delegate-enabled bill payment system 102 provides certain processes and graphics user interfaces suitable for delegate creation, management, and use, as further described below.

In certain examples, the account owner 108 initiates a bill payment delegation process by nominating one or more pending delegates from a pending delegate pool 120 or by entering a name, number, or other identifying information. The pending delegate pool 120 includes all users of the delegate-enabled bill payment system 102, such as users 122, 124, 126. The pending delegates nominated by the account owner 108 receive a notice of nomination from the delegate-enabled bill payment system 102. The pending delegates then user their existing login credentials to log into the delegate-enabled bill payment system 102 and to either accept or to turn down the nomination. If the nominations are accepted, the pending delegates (e.g., user 122, 126) then become delegates 128. Delegates 128 can then interact with the delegate-enabled bill payment system 102, e.g., via the secure login system 110, to initiate payments, view bill payment account activity, edit payments, add other delegates, and so on, based on their delegate role. A data store 130 is used to store delegate information, such as accounts assigned to the delegates, delegate status (e.g., current delegate, delegate that is yet to accept delegation (pending delegate), delegate that has turned down delegation, and so on), delegate limits (e.g., payment limits, time limits), delegate role, delegate activity logs, and so on. By providing for delegation of bill payment accounts 104 via the delegate-enabled bill payment system 102, the techniques described herein enable the distribution of bill payment activities among one or more delegates 128 in a more efficient and secure manner.

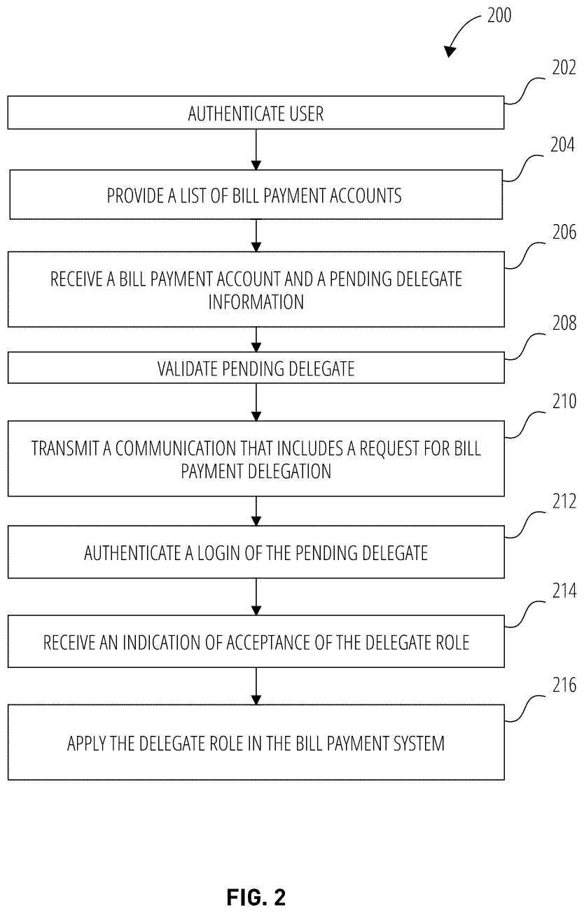

FIG. 2 illustrates an example flowchart for a bill payment delegation process 200, according to some embodiments. In the depicted example, the bill payment delegation process 200 authenticates a user at block 202. That is, the user enters certain login information, for example, into the delegate-enabled bill payment system 102, and the bill payment delegation process 200 authenticates the user based on the login information. Authentication can include multi-factor authentication that uses multiple independent ways of authenticating the user, in addition to a user/password combination. For example, multi-factor authentication can include transmitting a code to the user's mobile device, using biometrics, using a hardware key, and the like. When using a hardware key, a hardware device such as a universal serial bus (USB) device, plugs into a client device's USB slot to provide authentication information separate from the user/password combination.

Once the user is authenticated, the bill payment delegation process 200 provides, at block 204, a list of bill payment accounts to the user, such as the bill payment accounts 104 that are available for delegation by the user. For example, bill payment accounts 104 owned by the user (e.g., account owner 108) are presented at block 204. In some examples where the user is a delegate, e.g., one of the delegates 128, the bill payment delegation process 200 presents bill payment accounts that the delegate can delegate to others (e.g., when the delegate has the delegate full access role to certain bill payment accounts).

The bill payment delegation process 200 then receives, at block 206, a selection of a bill payment account from the list bill payment accounts, and a pending delegate information from the user (e.g., account owner 108). The pending delegate information includes a delegate role selection and certain other information. For example, a view only delegate role provides read-only access into the bill payment account, and thus the delegate is not able to initiate or to modify any payments. An edit only delegate role enables the editing (e.g., updating a monetary amount for a payment and/or editing a payment date) and canceling an existing payment, but cannot initiate a new payment. A cancel only delegate role enables only the canceling of a payment (e.g., due to an error). A delegate full access role enables the creation of a new payment, the viewing of bill payment account activity, the editing of an existing payment, delegating of the bill payment account to one more delegates, editing a delegate (e.g., changing a delegate role), and/or canceling delegation for a delegate.

The pending delegate information also includes certain limitations, such a limitation on the amount of funds that can be transferred for a given payment, a time that the user can participate as a delegate (e.g., delegation ends after a week, after a month, after a year, and so on), and/or limitations on who will received the payments (e.g., certain delegates can only pay certain entities). Pending delegate information also includes pending delegate identifying information. The pending delegate identifying information refers to information that uniquely identifies a user that is being nominated, e.g., by the account owner 108, to become a delegate for the selected bill payment account. Some examples of the pending delegate identifying information includes information such as an email, a phone number, and/or a financial account number associated with that user.

The pending delegate information entered is then validated at block 208. In certain embodiments, the pending delegates are validated by verifying that the pending delegates are current users of the delegate-enabled bill payment system 102. For example, the pending delegate identifying information is used by the delegate-enabled bill payment system 102 to search one or more data stores (e.g., data store 130) operatively coupled to the delegate-enabled bill payment system 102 to find the user associated with the pending delegate identifying information. If no user is found then the validation will not occur, and the account owner 108 is notified that no user exists that has the pending delegate identifying information. In some examples, the pending delegate that is not validated can become validated by entering certain user information (e.g., government identification such as a driver's license or passport, username, user password) and becoming a current user of the delegate-enabled bill payment systems 102.

The bill payment delegation process 200 then transmits, at block 210, a communication to the now validated pending delegate that includes a request to become a delegate for the bill payment account. In some examples, the communication is transmitted pending delegate identifying information via email and/or phone. Accordingly, an email, a text message, a voicemail, and so on, can be communicated to the pending delegate requesting acceptance as a delegate for the bill payment account.

The pending delegate then logs into the delegate-enabled bill payment system 102, at block 212. That is, the bill payment delegation process 200 will authenticate the pending delegate user, at block 212, by applying multi-factor authentication that uses other independent ways of authenticating the user, in addition to the user/password combination. The user's login information is linked to the pending delegate identifying information (e.g., email, phone number, and/or account number). The bill payment delegation process 200 will then receive, from the now authenticated pending delegate at block 214, an indication of acceptance of the delegate role. The bill payment delegation process 200, upon receiving an acceptance of the delegate role, will then apply, at block 216, the delegate role to the user in the delegate-enabled bill payment system 102. For example, the data store 130 can be updated to now have the delegate assigned to the bill payment account via a delegate role. The user will now be identified as a delegate for the bill payment account in subsequent logins. By providing for account delegation of bill payment accounts, the techniques described herein enable a more flexible and robust transfer of payment funds.

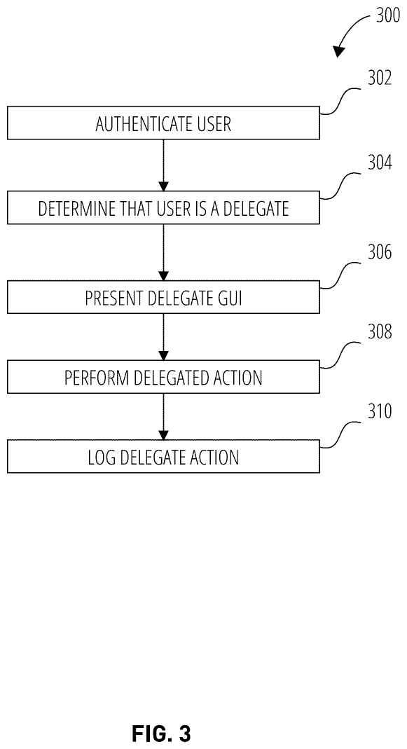

Turning now to FIG. 3, the figure is a flowchart of a bill payment process 300 suitable for applying one or more bill payment delegate actions, according to some embodiments. In the depicted embodiment, the bill payment process 300 authenticates a user, at block 302, such as a user logging into the delegate-enabled bill payment system 102. As mentioned earlier, the user is authenticated, at block 302, by applying multi-factor authentication that uses other independent ways of authenticating the user, in addition to the user/password combination, such as by transmitting a code to the user's mobile device, using biometrics, applying facial recognition, and so on.

Once the user is authenticated, the bill payment process 300 determines, at block 304, if the now authenticated user is a delegate for one or more bill payment accounts 104. For example, the data store 130 can be used to query a delegate table storing a list of delegates and delegated accounts. For users that are determined to be delegates, the bill payment process 300, at block 306, presents a delegate GUI that includes GUI controls views, useful for performing various delegate actions. Accordingly, the user can interact with the GUI at block 308, to perform a desired delegate actions.

The delegate actions vary based on delegate role. As mentioned earlier, various delegate roles are provided. Actions for the view-only delegate role include viewing a selection of transactions for the bill payment account. The transactions can be viewed chronologically (e.g., from newest to oldest or vice versa), for a given date range (e.g, for week, for a month), for a given amount range (e.g., between $100 to $5000) and/or for a given payee entity 112. Actions for the edit only delegate role include viewing all payments that are not completed and updating the payments, such as by changing a payment amount, by changing a date for completing the payment, and/or by canceling the payment. Actions for the cancel only delegate role include viewing payments that have not been completed and canceling any uncompleted payments. Actions for the delegate full access role include initiating a new payment, viewing delegate account activity, editing a payment, canceling a payment, adding new delegates, editing a delegate (e.g., changing a delegate role), and/or canceling delegation for a delegate. The bill payment process 300 will additionally log, at block 310, all delegate actions for review. For example, the data store 130 includes a delegate log table used to store delegate actions for each delegate and the dates that the delegate actions took place.

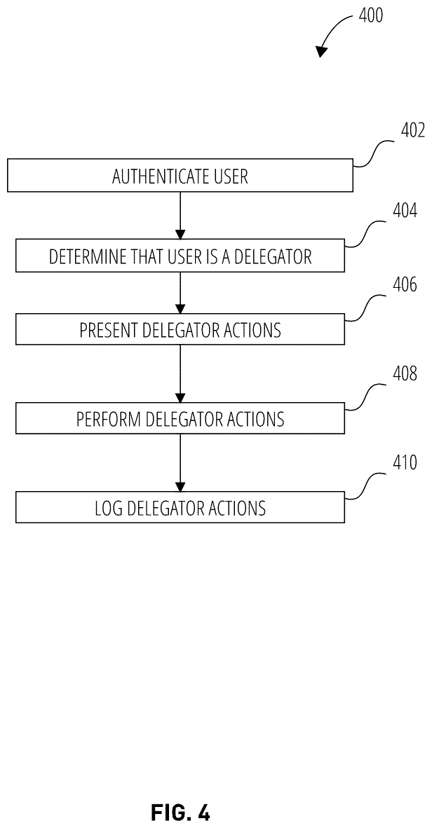

Turning now to FIG. 4, the figure is a flowchart illustrating an example bill payment delegator process 400 suitable for applying one or more bill payment delegator actions, according to some embodiments. In the depicted embodiment, the bill payment delegator process 400 authenticates a user, at block 402, such as a user logging into the delegate-enabled bill payment system 102. The user is authenticated, at block 402, by applying multi-factor authentication that uses other independent ways of authenticating the user, in addition to the user/password combination, including transmitting a code to the user's mobile device, using biometrics, applying facial recognition, and so on.

Once the user is authenticated, the bill payment delegator process 400 determines, at block 404, that a user is a delegator that has delegated access to one or more bill payment accounts 104. For example, the data store 130 can be used to query a delegator table storing a list of delegators and delegated accounts for each delegator, as well as the delegates for each delegated account. For users that are determined to be delegators, the bill payment delegator process 400, at block 406, presents a delegator GUI that useful for performing various delegator actions. Accordingly, the user can interact with the GUI and the bill payment delegator process 400, at block 408, will perform a desired delegator user action.

Delegator actions include removing users as delegates, viewing delegate status (e.g., active delegate, inactive delegate, pending delegate), changing delegate status, adding new delegates, and/or viewing actions that the delegates have performed. In certain examples, viewing the delegate actions include querying the log table(s) in the data store 130 to retrieve one or more actions that have been performed by certain delegates. The delegate actions vary based on a delegate role, and include viewing accounts, creating payments, canceling payments, adding new delegates, editing a delegate (e.g., changing a delegate role), and/or canceling delegation for a delegate, and so on. The bill payment delegator process 400 also logs delegator actions, at block 410, for example, by using the log table(s).

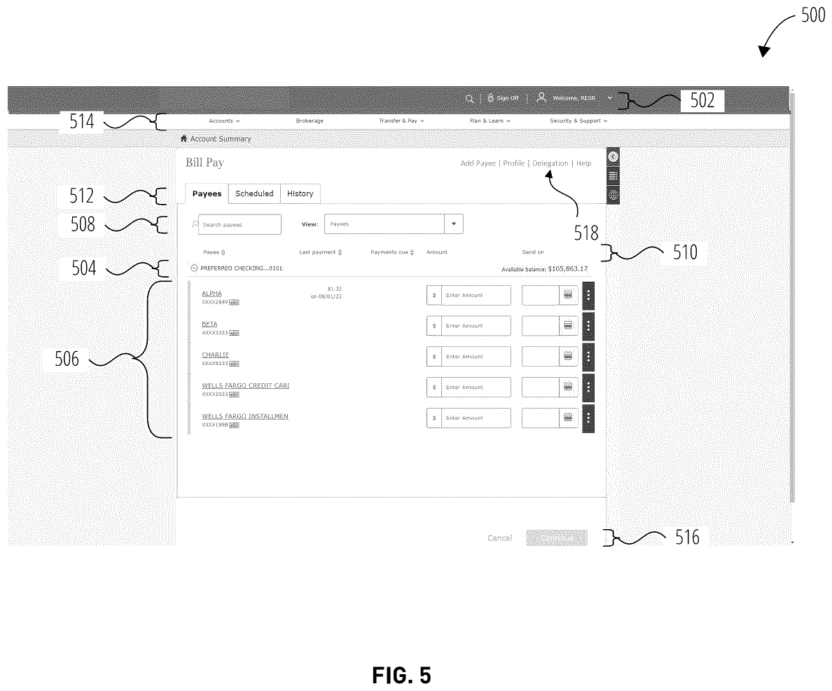

FIG. 5 is screenshot of an example GUI 500 that can be used to display a bill payment account summary and to navigate to certain account delegation views, according to some embodiments. In the depicted example, once a user has been authenticated (e.g., via multi-factor authentication), the GUI 500 will display a section 502 showing a user's login name in a dropdown control, as well as a control to sign off. The GUI 500 also includes a section 504 that displays bill payment account information (e.g., account name and last few digits of the account number), as well as an available account balance. A section 506 displays a list of payees and payee information, including additional GUI controls that are used to set up bill payment fund transfers to a given payee.

In the illustrated example, the section 506 displays payee names, a last few digits of each payee's account number, and includes GUI controls to enter an amount of funds to transfer to each payee as well a date control suitable for selecting a payment date. “Dot” controls are also displayed, which when activated, enable further functionality such as removing the payee from the bill payment account, editing payee information, and so on. Section 508 is used to search for certain payees, for example, by entering a payee name in a text control, as well to switch to viewing other information, e.g., other account information.

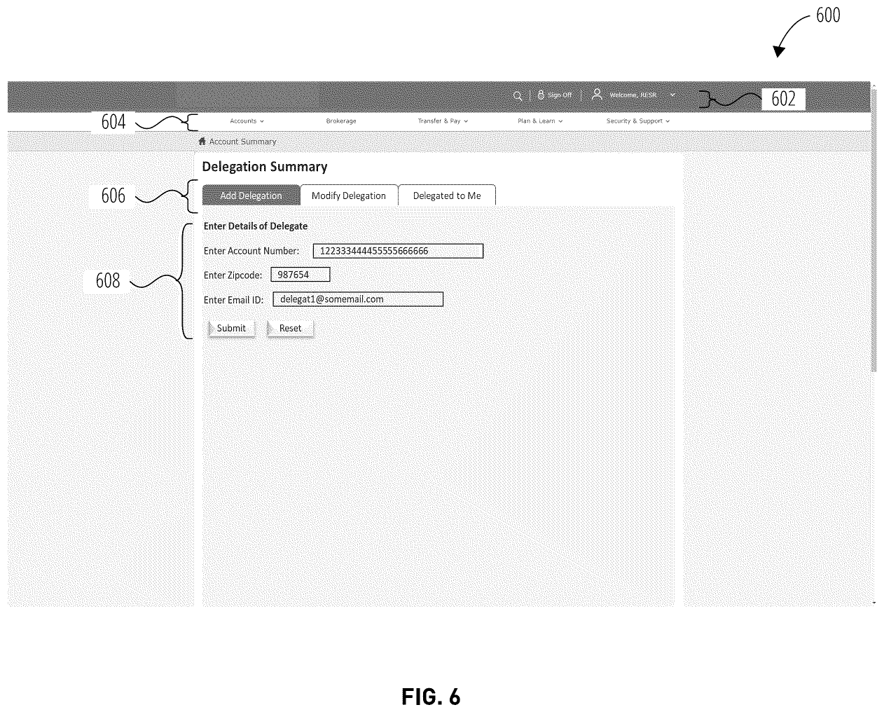

Section 510 includes GUI controls to reorder the section 506 display, such as by payee name, by last payment, by when payment is due, by payment amount, and by when the payment is to be sent. Section 512 includes tabs suitable for switching between information related to payees, to information related to scheduled payments, and additionally to information related to a history of bill payments. Likewise, section 514 includes GUI controls (e.g., drop down and link controls), suitable for navigating to other accounts functionality, brokerage functionality, transfer and pay functionality, plan and learn functionality, and security and support functionality. Button GUI controls in section 516 provide for canceling and continuation functionality. The user can select bill delegation functionality, for example, by activating a link control 518. Activating (e.g., clicking) the link control 518 will then result in the presentation of a delegation summary GUI, as described in more detail below with respect to FIG. 6.

FIG. 6 is screenshot of an example GUI 600 that can be used to display delegation summaries and to provide certain delegation functionality, according to some embodiments. In the depicted example, the GUI 600 shown can be launched by activating the link control 518 shown in FIG. 5. The GUI 600 includes a section 602 showing a user's login name in a dropdown control, as well as a control to sign off. A section 604 is also illustrated. The section 604 includes GUI controls (e.g., drop down and link controls), suitable for navigating to other accounts functionality, brokerage functionality, transfer and pay functionality, plan and learn functionality, and security and support functionality. A section 606 is also shown, which includes tabs useful in presenting and/or modifying certain delegation information.

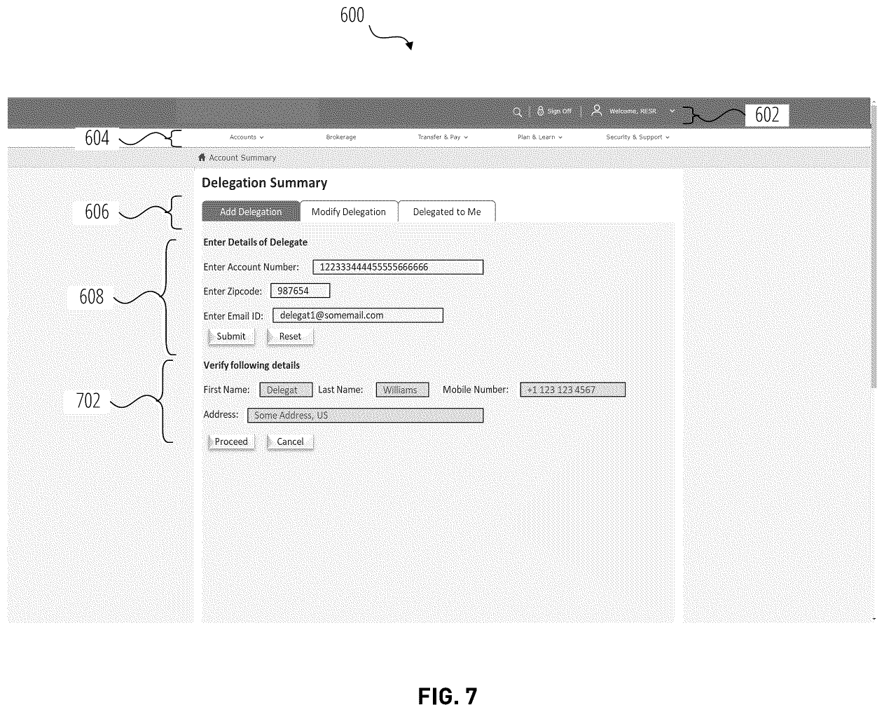

In the depicted example, a section 608 is used to enter details for a pending delegate (e.g., new delegate). In the depicted example, the user (e.g., account owner 108) enters a pending delegate account number (e.g, banking account number), a zip code for the pending delegate, and a pending delegate's email. The user then activates a submit button control to request validation of the pending delegate or a reset button control to delete any information entered in the section 608. Activation of the submit button the results in the GUI 600 dynamically creating a new section that is positioned below section 608, as shown in FIG. 7.

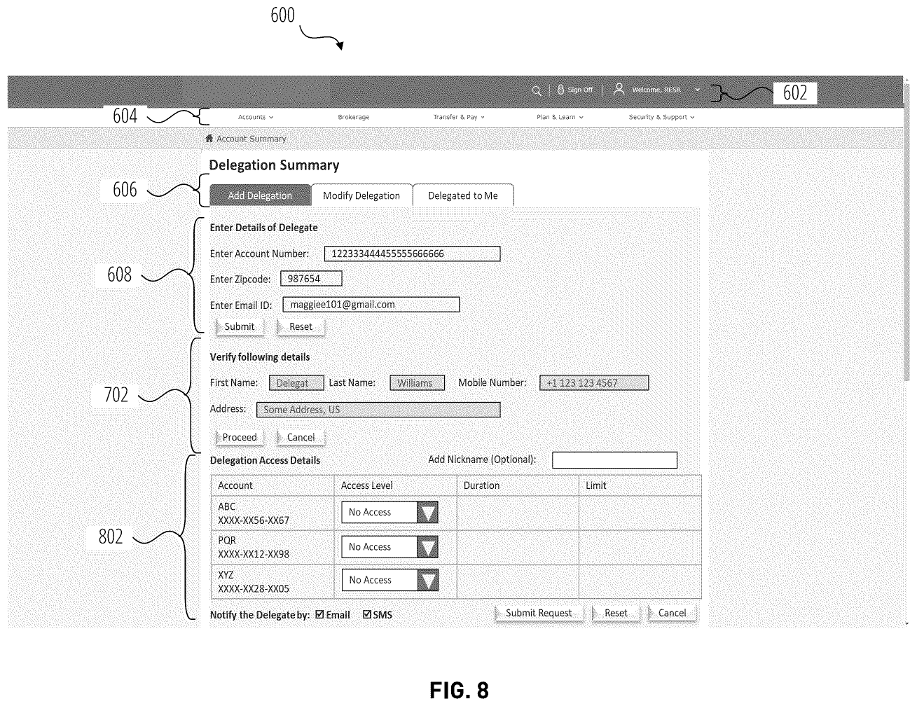

More specifically, FIG. 7 is a screenshot illustrating the GUI 600 of FIG. 6 now displaying a new section 702 that has been dynamically created, according to some embodiments. In the depicted example, the section 702 is displayed after the user activates the submit button control of section 608. More specifically, activating the submit button control of section 608 causes the GUI 600 to use the pending delegate information entered by the user in section 608 to retrieve pending delegate information from a data store (e.g., data store 130) for verification by the user. That is, the pending delegate information is used to query the data store for additional pending delegate information which is then displayed in section 702. If the query does not find any information, then the pending delegate entered by the user is considered an invalid delegate (e.g., a non-existent user). In the depicted embodiment, the verification information retrieved and displayed in section 702 includes a first name and last name of the pending delegate, a phone number, and an address. The user uses the verification information displayed in section 702 to determine if the pending delegate is the correct entity that will become a delegate for the bill payment account. If the verification information is deemed as correct, the user can then activate a proceed button control included in section 702. If the verification information is incorrect, the user can activate a cancel button control. Activation of the proceed button control of section 702 then results in the GUI 600 dynamically creating a new section below section 702, as shown in FIG. 8.

FIG. 8 is a screen shot illustrating the GUI 600 when the GUI 600 displays a new delegation access details section 802, according to some embodiments. In the depicted embodiment, the section 802 is displayed after the user activates the proceed button control of section 702. More specifically, activating the proceed button control of section 702 results in a list of bill payment accounts being displayed in section 802 so that the user can select one or more of the displayed bill payment accounts for delegation. The user also selects, for each displayed bill payment account, a delegate role (e.g., access level), a delegate duration (e.g., how long will the delegation last), and a payment limit (e.g., maximum amount of funds that the delegate can transfer from the bill payment account in a single payment).

Checkbox controls for selection of a notification mechanism when notifying the delegate are also displayed in section 802. In the depicted example, the pending delegate can be notified via email and/or SMS by selecting the corresponding checkbox controls of section 802. Once the user has selected one or more accounts for delegation in section 802, the user can then activate a submit request button control in section 802. Activating the submit request button control will cause the GUI 500 to communicate a delegation request to the pending delegate via the preferred notification mechanisms (e.g., email, SMS). Reset and cancel button controls are also provided in section 802, suitable for resetting section 802 (e.g., deleting existing information in input controls) and canceling out of section 802, respectively.

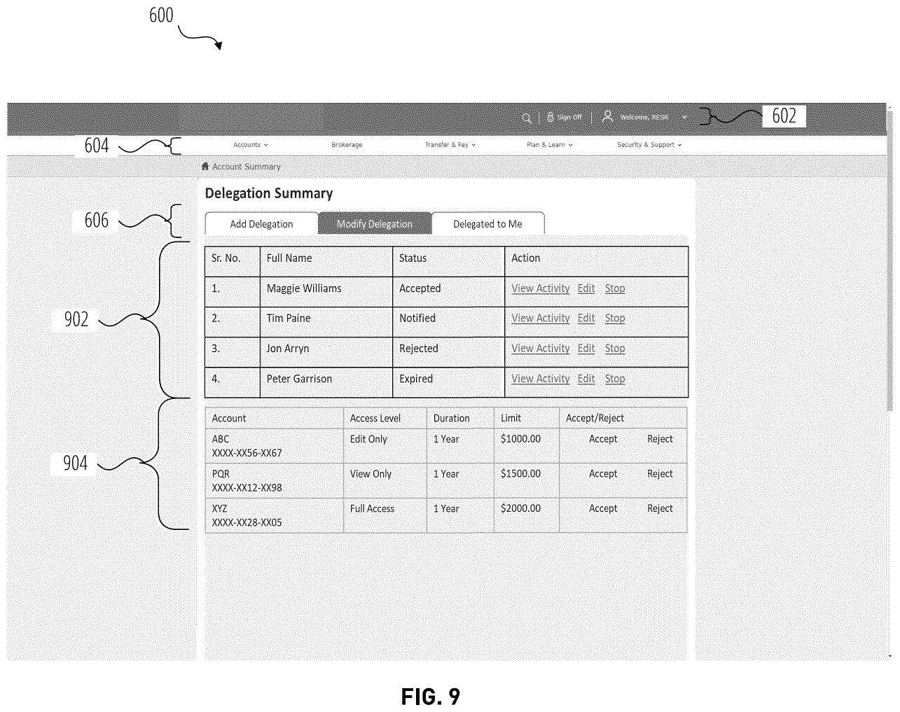

Turning now to FIG. 9, the figure is a screenshot illustrating the GUI 600 after the activation of the “modify delegate” tab of the section 606, according to some embodiments. In the depicted example, a section 902 of the GUI 600 displays a list of delegates for a bill payment account. The section 902 uses a tabular view having a senior number (Sr. No.) column representative of a seniority for each delegate (or for each pending delegate if the there is no current acceptance of delegation), a full name column, an acceptance status representative of acceptance of delegation, and an action column having various link controls. The link controls in the action column provides further functionality for each delegate, such as viewing the delegate's activity, editing delegate information (e.g., changing delegate role), and/or stopping delegation.

A section 904 of the GUI 600 is also depicted. In one example, the section 904 displays additional information for a delegate listed in section 902. That is, the user can select a delegate (or a pending delegate) in section 902 and the GUI 600 will then dynamically display the delegate's (or the pending delegate's) information in section 904. For example, section 904 displays a bill payment account, a delegate role (e.g., access level), a duration of delegation, a limit on funds transferred, and an acceptance or rejection status.

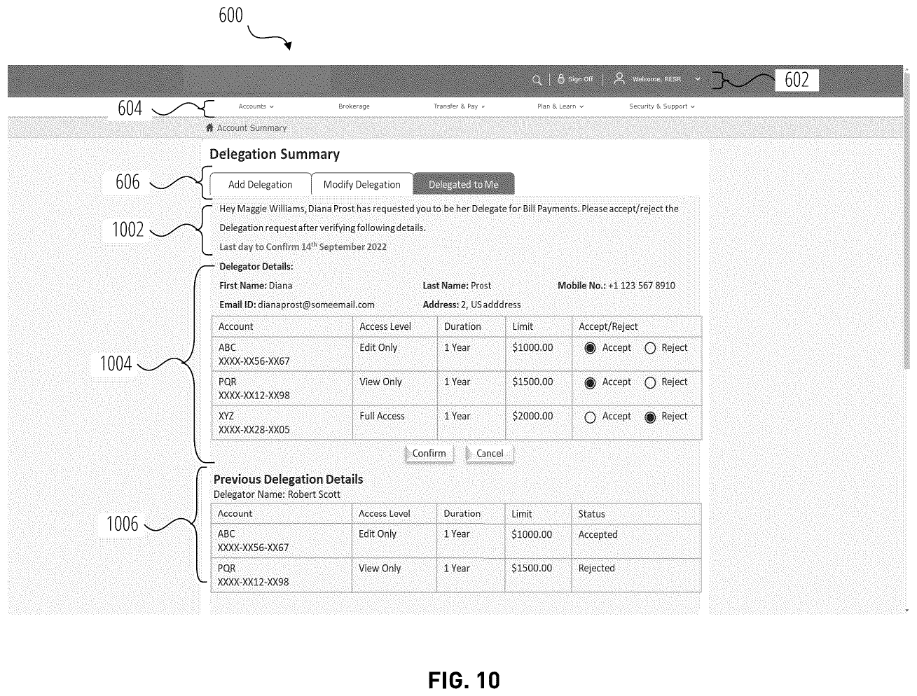

FIG. 10 is a screenshot of the GUI 600 illustrating the activation of the “delegated to me” tab of the section 606, according to some embodiments. In the depicted example, the GUI 600 includes a section 1002 that shows notification information that a delegation request has been made. That is, the user has received a request to participate as a delegate for one or more bill payment accounts. In the depicted example, the information presented by section 1002 includes a name of the user (e.g., delegator) that has sent the delegation request, and a date by which the delegation request should be accepted. If the date is missed, the delegation request is considered expired, and the pending delegate cannot accept the request.

A section 1004 is also shown, which includes further information for the delegator, such as a phone number and email, as well as a tabular view of the bill payment accounts that the delegator has selected for delegation. The tabular view includes an accept/reject column having radio button controls suitable for accepting or for rejecting delegation of a bill payment account. Accordingly, the user (e.g., pending delegate) can select an acceptance or a rejection of delegation for a given bill payment account and then activate a confirm button control. Activation of the confirm button control will cause the GUI 500 to then process either the acceptance or the rejection of delegation for specific bill payment account(s). A cancel button control disposed in the section 1004 can be used to cancel further processing. Acceptance of the request will cause the GUI 500 (e.g, provided by the delegate-enabled bill payment system 102) to apply

A section 1006 is additionally illustrated, which is used to present previous delegation details. In the illustrated example, a tabular view in section 1006 is used to present one or more bill payment accounts that have been delegated to the user by a given delegator, as well as one or more bill payment accounts that the user has not accepted for delegation. Other information displayed by section 1006 includes, for each bill payment account, a delegate role (e.g., access level), a duration of delegation, a limit for funds transfer, and a status of delegation (e.g., accepted, rejected, pending).

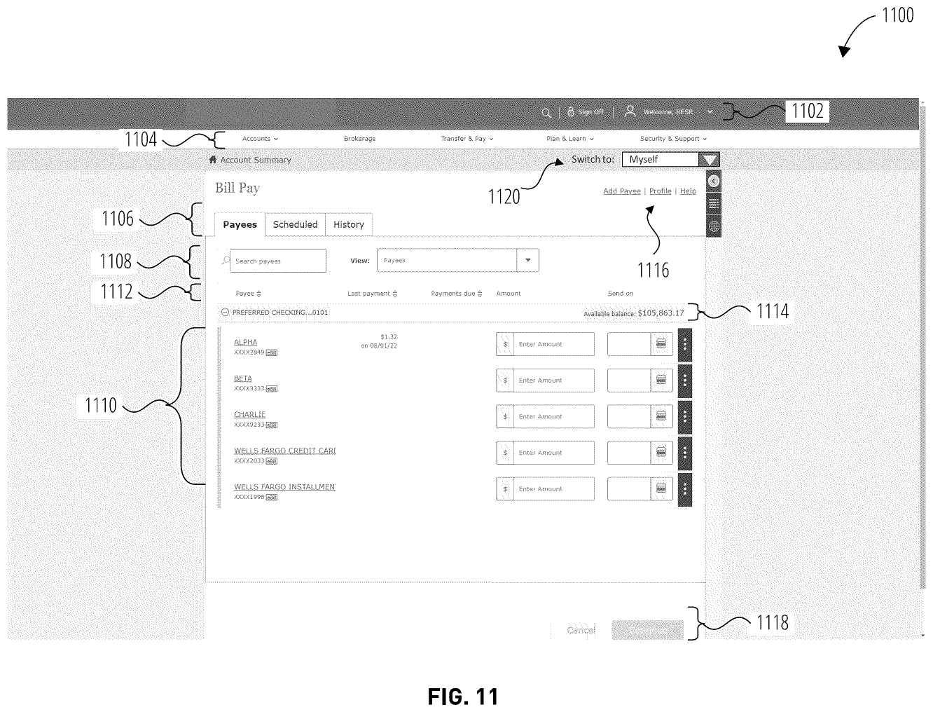

FIG. 11 is a screenshot of a GUI 1100 suitable for switching between various delegated accounts, according to some embodiments. In the depicted embodiment, the GUI 1100 includes a section 1102 that displays the user's login name in a dropdown control, as well as a control to sign off. A section 1104 is also illustrated. The section 1104 includes GUI controls (e.g., drop down and link controls), suitable for navigating to other accounts functionality, brokerage functionality, transfer and pay functionality, plan and learn functionality, and security and support functionality. A section 1106 is also shown, which includes tabs useful in presenting bill payment account information, including payees, scheduled payments, and history of payments.

The GUI 1100 also includes a section 1108. The section 1108 includes a search control for searching information (e.g., searching for a payee) and a dropdown control for switching among various views. The current view is displayed in section 1110, which in the depicted example shows a list of payee accounts. The payee accounts are shown in tabular format, with a control to enter a payment amount and a calendar control to enter a date for the payment. “Dot” controls are also displayed for each account, which when activated, enable further functionality such as removing the payee from the bill payment account, editing payee information, and so on.

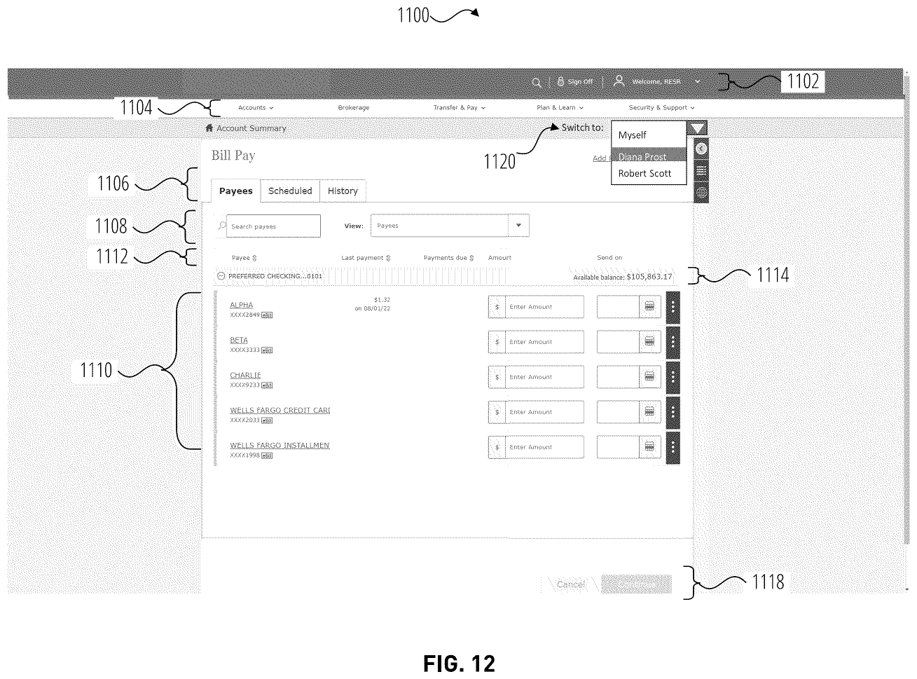

Section 1112 includes controls to reorder the section 1110 display, such as by payee name, by last payment, by when payment is due, by amount, and by when the payment is to be sent. Section 1114 is also shown, displaying bill payment account information (e.g., account name and last few digits of the account number), as well as an available account balance. Section 1116 includes link controls for adding payees, viewing a user profile, and viewing help pages, while section 1116 provides for canceling out of the GUI 1100 or processing any changes to the information in section 1110. A section 1118 is shown, that includes controls for canceling and for continuing processing the information entered. The GUI 1100 also includes a delegation control 1120 suitable for switching into a delegate of a given user. In the depicted embodiment, activation of the delegation control 1120 results in a list of delegators that have delegated access to the current user, as shown below in FIG. 12.

FIG. 12 is a screenshot of the GUI 1100 illustrating an activation of the delegation control 1120, in accordance with some embodiments. In the depicted example, the activation of the delegation control 1120 shows a list of delegators. Accordingly, the current user can select a delegator from the list and become a delegate for the selected delegator. Once the delegator is selected, section 1110 will then update to now show a list of bill payment accounts belonging to the delegator that the user has delegate access to.

The user, which after activating the delegation control 1120 has now become a delegate (e.g., delegate for the delegator Diana Prost in the depicted example), can now enter a payment amount, view a payment amount, enter a payment date, view a payment date, and so on, for bill payment accounts delegated via the Diana Prost delegator. It is to be noted that the interface used to edit, update, view, and/or cancel payments is the same for bill payment accounts owned by the user or delegated to the user. Accordingly, the user can leverage their knowledge and experience of using the GUI for both paying accounts owned by the user as well as for accounts delegated to the user. For accounts owned by the user, the user can select “Myself” when activating the delegation control 1120, and section 1110 will update to only show bill payment accounts owned by the current user. That is, a “Myself” delegator selection will show only bill payment accounts owned by the current user.

It is to be noted that the GUI visualizations described herein, e.g., GUI 500, GUI 600, and/or GUI 1100, can be provided by the delegate-enabled bill payment system 102. Further, the GUI 500, GUI 600 and/or GUI 1100 can be provided as part of an online system (e.g., website), as part of a client-based software application (e.g., mobile app, desktop application), as part of a cloud system, or a combination thereof. By providing for flexible visualizations and presentation of delegation information, the techniques described herein enable more efficient delegation of bill payment accounts.

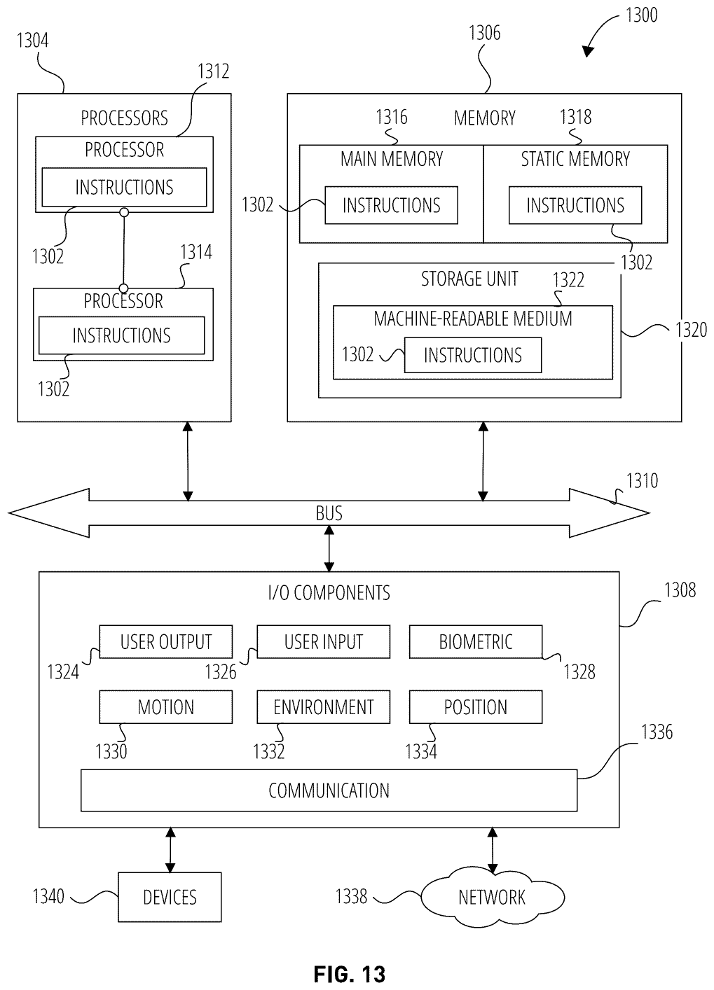

FIG. 13 is a diagrammatic representation of a machine 1300 within which instructions 1302 (e.g., software, a program, an application, an applet, an app, or other executable code) for causing the machine 1300 to perform any one or more of the methodologies discussed herein may be executed. For example, the instructions 1302 may cause the machine 1300 to execute any one or more of the processes or methods described herein, such as the processes 200, 300, and 400. The instructions 1302 transform the general, non-programmed machine 1300 into a particular machine 1300, e.g., the delegate-enabled bill payment system 102 system, programmed to carry out the described and illustrated functions in the manner described, e.g., the GUIs 500, 600, 1100. The machine 1300 may operate as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1302, sequentially or otherwise, that specify actions to be taken by the machine 1300. Further, while a single machine 1300 is illustrated, the term “machine” shall also be taken to include a collection of machines that individually or jointly execute the instructions 1302 to perform any one or more of the methodologies discussed herein. In some examples, the machine 1300 may also comprise both client and server systems, with certain operations of a particular method or algorithm being performed on the server-side and with certain operations of the particular method or algorithm being performed on the client-side.

The machine 1300 may include processors 1304, memory 1306, and input/output I/O components 1308, which may be configured to communicate with each other via a bus 1310. In an example, the processors 1304 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 1312 and a processor 1314 that execute the instructions 1302. The term “processor” is intended to include multi-core processors that may comprise two or more independent processors (sometimes referred to as “cores”) that may execute instructions contemporaneously. Although FIG. 13 shows multiple processors 1304, the machine 1300 may include a single processor with a single-core, a single processor with multiple cores (e.g., a multi-core processor), multiple processors with a single core, multiple processors with multiples cores, or any combination thereof.

The memory 1306 includes a main memory 1316, a static memory 1318, and a storage unit 1320, both accessible to the processors 1304 via the bus 1310. The main memory 1316, the static memory 1318, and storage unit 1320 store the instructions 1302 embodying any one or more of the methodologies or functions described herein. The instructions 1302 may also reside, completely or partially, within the main memory 1316, within the static memory 1318, within machine-readable medium 1322 within the storage unit 1320, within at least one of the processors 1304 (e.g., within the processor's cache memory), or any suitable combination thereof, during execution thereof by the machine 1300.

The I/O components 1308 may include a wide variety of components to receive input, provide output, produce output, transmit information, exchange information, capture measurements, and so on. The specific I/O components 1308 that are included in a particular machine will depend on the type of machine. For example, portable machines such as mobile phones may include a touch input device or other such input mechanisms, while a headless server machine will likely not include such a touch input device. It will be appreciated that the I/O components 1308 may include many other components that are not shown in FIG. 13. In various examples, the I/O components 1308 may include user output components 1324 and user input components 1326. The user output components 1324 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1326 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1308 may include biometric components 1328, motion components 1330, environmental components 1332, or position components 1334, among a wide array of other components. For example, the biometric components 1328 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1330 include acceleration sensor components (e.g., accelerometer), gravitation sensor components, rotation sensor components (e.g., gyroscope).

The environmental components 1332 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1334 include location sensor components (e.g., a global positioning system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1308 further include communication components 1336 operable to couple the machine 1300 to a network 1338 or devices 1340 via respective coupling or connections. For example, the communication components 1336 may include a network interface component or another suitable device to interface with the network 1338. In further examples, the communication components 1336 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1340 may be another machine or any of a wide variety of peripheral devices (e.g., a peripheral device coupled via a universal serial bus (USB) port), internet-of-things (IoT) devices, and the like.

Moreover, the communication components 1336 may detect identifiers or include components operable to detect identifiers. For example, the communication components 1336 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1336, such as location via Internet Protocol (IP) geolocation, location via Wi-Fi® signal triangulation, location via detecting an NFC beacon signal that may indicate a particular location, and so forth.

The various memories (e.g., main memory 1316, static memory 1318, and memory of the processors 1304) and storage unit 1320 may store one or more sets of instructions and data structures (e.g., software) embodying or used by any one or more of the methodologies or functions described herein. These instructions (e.g., the instructions 1302), when executed by processors 1304, cause various operations to implement the disclosed examples.

The instructions 1302 may be transmitted or received over the network 1338, using a transmission medium, via a network interface device (e.g., a network interface component included in the communication components 1336) and using any one of several well-known transfer protocols (e.g., hypertext transfer protocol (HTTP)). Similarly, the instructions 1302 may be transmitted or received using a transmission medium via a coupling (e.g., a peer-to-peer coupling) to the devices 1340. In some examples, the machine 1300 and/or the one or more of the devices 1340 at virtual reality devices, augmented reality devices, and/or mixed reality devices suitable for presenting the visualizations described herein, such as the visualizations presented at block 404 of FIG. 4.

The techniques described herein provide for online delegation of bill payment accounts. An account owner for a bill payment account or a user having a delegate full access role to the bill payment account can delegate various roles for bill payment purposes. Delegate roles provide for added security by compartmentalizing bill payment account access. Delegate roles include a delegate full access role providing for a creation of a money transfer, for a viewing of bill payment account activity, for an editing of an existing money transfer, and/or for an updating of a monetary account for an existing money transfer. A view only delegate role provides for the viewing of bill payment activity. An edit only delegate role providing for the updating the monetary amount for the existing money transfer. A pending delegate user is selected and verified, and a communication requesting bill payment delegation is then sent to the pending delegate user. The pending delegate user can then accept the bill payment delegation and become a delegate. The delegate can then access the bill payment account to perform certain actions (e.g., view account activity, edit account activity, create a new bill payment fund transfer). Delegate activity is captured (e.g., via a log), and presented for viewing.

1. A delegate-enabled bill payment system, comprising:
one or more hardware processors; and
at least one memory storing instructions that cause the one or more hardware processors to perform operations comprising:
presenting, to a user via a graphical user interface (GUI), a list of bill payment accounts included in a bill payment system wherein each bill payment account in the list of bill payment accounts is delegable by the user, wherein the list of bill payment accounts comprises a first list of bill payment accounts owned by the user and a second list of bill payment accounts delegated to the user, and wherein the bill payment system is configured to transfer funds from a bill payment account included in the second list of bill payment accounts into a payee account via a fund transfer network;
receiving, from the user via the GUI, a selection of the bill payment account included in the first list of bill payment accounts and a pending delegate identifying information, wherein the pending delegate identifying information comprises an email, a short message service (sms) identifier, a notification identifier, or a combination thereof;
transmitting, via a second email, via a second sms, via a second notification, or a combination thereof, a first communication comprising a request for bill payment delegation based on the selection and on the pending delegate identifying information;
authenticating a second user via a user credential linked to the pending delegate identifying information;
receiving, via a second communication sent from a client computing device sent by the second user, an indication of acceptance of a delegate role for the bill payment account;
applying the delegate role in the bill payment system to enable access to the bill payment account via the user credential based on the indication of acceptance;
authenticating a login of the second user into the bill payment system;
presenting, to the second user after authentication, a second GUI comprising a GUI control to pay a bill using the bill payment account; and
transferring, via the fund transfer network, the funds from the bill payment account into the payee account when the GUI control to pay the bill is activated.

2. The delegate-enabled bill payment system of claim 1, wherein the operations comprise:
receiving, from a third user, a third user credential for accessing the bill payment system;
verifying the third user credential as authenticating a delegate for one or more bill payment accounts of the list of bill payment accounts;
presenting, to the third user, a list of delegators for the one or more bill payment accounts;
receiving, from the third user, a delegator selection for a delegator in the list of delegators; and
presenting, to the third user, a third GUI comprising a first section having a bill payment amount control configured to receive an amount to pay a payee of the one or more bill payment accounts based on the delegator selection.

3. The delegate-enabled bill payment system of claim 2, wherein the operations comprise, receiving, via the bill payment amount control, the amount to pay the payee, and paying the amount via a payment network.

4. The delegate-enabled bill payment system of claim 3, wherein the operations comprise, presenting, to the third user, the GUI comprising a calendar control configured to receive a payment date, wherein the operations comprise, receiving, via the calendar control, the payment date, and wherein paying the amount comprises paying the amount at the payment date.

5. The delegate-enabled bill payment system of claim 2, wherein the operations comprise:
receiving, from the third user, a second delegator selection for a second delegator in the list of delegators;
removing, from the first section, the bill payment amount control; and
presenting, to the third user, the first section comprising a second bill payment amount GUI control configured to receive a second amount to pay a second payee of the one or more bill payment accounts based on the second delegator selection.

6. The delegate-enabled bill payment system of claim 2, wherein the list of delegators comprises a “Myself” delegator, wherein the “Myself” delegator is representative of the one or more bill payment accounts that are owned by the third user, and wherein the second delegator is representative of the one or more bill payment accounts that are owned by the first user or by the second user.

7. The delegate-enabled bill payment system of claim 6, wherein the operations comprise:
receiving, from the third user, a “Myself” delegator selection for the “Myself” delegator in the list of delegators; and
presenting, to the third user, the first section having the bill payment amount control configured to receive the amount to pay the payee of the one or more bill payment accounts owned by the third user.

8. The delegate-enabled bill payment system of claim 2, wherein verifying the third user credential as authenticating the delegate for the one or more bill payment accounts comprises determining a delegate role for the delegate.

9. The delegate-enabled bill payment system of claim 8, wherein the delegate role comprises a delegate full access role providing for a creation of a payment, for a viewing of bill payment account activity, for an updating a monetary amount for an existing payment, for changing a payment date, for a changing of a payee for the existing payment, for a canceling of the payment, for delegating of the bill payment account, for editing the delegate, for canceling delegation for the delegate, or a combination thereof; a pay only delegate role providing for the creation of a payment; an edit only delegate role providing for updating the monetary amount for the existing payment, for the changing of the payment date, for the canceling of the payment, or a combination thereof; a view only delegate role providing for the viewing of bill payment activity; or a combination thereof.

10. The delegate-enabled bill payment system of claim 1, wherein applying the delegate role in the bill payment system to enable access to the bill payment account comprises applying a time limit to access the bill payment account.

11. The delegate-enabled bill payment system of claim 1, wherein applying the delegate role in the bill payment system to enable access to the bill payment account comprises applying an amount limit to transfer funds from the bill payment account.

12. The delegate-enabled bill payment system of claim 1, wherein the operations comprise:
presenting, to the user, a list of delegates having delegate access to the list of bill payment accounts;
receiving, from the user, a delegate selection for a delegate included in the list of delegates and an indication to cancel delegate access or to modify delegate access; and
canceling or modifying the delegate access based on the indication.

13. The delegate-enabled bill payment system of claim 1, wherein modifying the delegate access comprises changing the delegate role for the delegate to a second delegate role.

14. The delegate-enabled bill payment system of claim 1, wherein the operations comprise:
presenting, to the user, a list of delegates having delegate access to the list of bill payment accounts;
receiving, from the user, a delegate selection for a delegate included in the list of delegates; and
presenting a log of bill payment account activities based on the delegate selection.

15. The delegate-enabled bill payment system of claim 14, wherein the log of bill payment account activities comprises a list of all payments made by the delegate for the list of bill payment accounts, a list of all changes to payments for the list of bill payments accounts, and a list of all canceled payments for the list of bill payment accounts.

16. The delegate-enabled bill payment system of claim 1, wherein the operations comprise authenticating the user using multi-factor authentication before presenting, to the user, the list of bill payment accounts, and wherein authenticating the second user comprises using multi-factor authentication to authenticate the second user.

17. The delegate-enabled bill payment system of claim 1, wherein each bill payment account in the list of bill payments is delegable by the user when the user is an account owner or when the user has the delegate role comprising a delegate full access role.

18. A machine-readable medium storing instructions that, when executed by a computer system, cause the computer system to perform operations comprising:
presenting, to a user via a graphical user interface (GUI), a list of bill payment accounts included in a bill payment system, wherein each bill payment account in the list of bill payment accounts is delegable by the user, wherein the list of bill payment accounts comprises a first list of bill payment accounts owned by the user and a second list of bill payment accounts delegated to the user, and wherein the bill payment system is configured to transfer funds from a bill payment account included in the second list of bill payment accounts into a payee account via a fund transfer network;
receiving, from the user via the GUI, a selection of the bill payment account included in the list of bill payment accounts and a pending delegate identifying information, wherein the pending delegate identifying information comprises an email, a short message service (sms) identifier, a notification identifier, or a combination thereof;
transmitting, via a second email, via a second sms, via a second notification, or a combination thereof, a first communication comprising a request for bill payment delegation based on the selection and on the pending delegate identifying information;
authenticating a second user via a user credential linked to the pending delegate identifying information;
receiving, via a second communication sent from a client computing device sent by from the second user, an indication of acceptance of a delegate role for the bill payment account;
applying the delegate role in the bill payment system to enable access to the bill payment account via the user credential based on the indication of acceptance
authenticating a login of the second user into the bill payment system;
presenting, to the second user after authentication, a second GUI comprising a GUI control to pay a bill using the bill payment account; and
transferring, via the fund transfer network, the funds from the bill payment account into the payee account when the GUI control to pay the bill is activated.

19. The machine-readable medium storing instructions of claim 18, wherein the operations comprise:
receiving, from a third user, a third user credential for accessing the bill payment system;
verifying the third user credential as authenticating a delegate for one or more bill payment accounts of the list of bill payment accounts;
presenting, to the third user, a list of delegators for the one or more bill payment accounts;
receiving, from the third user, a delegator selection for a delegator in the list of delegators; and
presenting, to the third user, a third GUI comprising a first section having a bill payment amount control configured to receive an amount to pay a payee of the one or more bill payment accounts based on the delegator selection.

20. A method comprising:
presenting, to a user via a graphical user interface (GUI), a list of bill payment accounts included in a bill payment system, wherein each bill payment account in the list of bill payment accounts is delegable by the user, wherein the list of bill payment accounts comprises a first list of bill payment accounts owned by the user and a second list of bill payment accounts delegated to the user, and wherein the bill payment system is configured to transfer funds from a bill payment account included in the second list of bill payment accounts into a payee account via a fund transfer network;
receiving, from the user via the GUI, a selection of the bill payment account included in the list of bill payment accounts and a pending delegate identifying information, wherein the pending delegate identifying information comprises an email, a short message service (sms) identifier, a notification identifier, or a combination thereof;
transmitting, via a second email, via a second sms, via a second notification, or a combination thereof, a first communication comprising a request for bill payment delegation based on the selection and on the pending delegate identifying information;
authenticating a second user via a user credential linked to the pending delegate identifying information;
receiving, via a second communication sent from a client computing device sent by from the second user, an indication of acceptance of a delegate role for the bill payment account;
applying the delegate role in the bill payment system to enable access to the bill payment account via the user credential based on the indication of acceptance;
authenticating a login of the second user into the bill payment system;
presenting, to the second user after authentication, a second GUI comprising a GUI control to pay a bill using the bill payment account; and
transferring, via the fund transfer network, the funds from the bill payment account into the payee account when the GUI control to pay the bill is activated.
